(19) United States
(12) Patent Application Publication
(10) Pub. No.: US 2025/0207782 A1
(43) Pub. Date: Jun. 26, 2025

(54) APPARATUS FOR FUEL-AIR MIXING AND FLAME-HOLDING IN PULSE COMBUSTORS

(71) Applicant: North American Wave Engine Corporation, Baltimore, MD (US)

(72) Inventors: Daanish MAQBOOL, North Bethesda, MD (US); Sean LACY, Baltimore, MD (US)

(21) Appl. No.: 18/990,902

(22) Filed: Dec. 20, 2024

Related U.S. Application Data
(60) Provisional application No. 63/613,632, filed on Dec. 21, 2023.

(51) Int. Cl. F23R 7/00; F23R 3/28; F23R 3/34

(52) U.S. Cl. CPC F23R 7/00; F23R 3/286; F23R 3/346; F23R 2900/03282

(57) ABSTRACT

A system and method are disclosed for improving the operation of pulse combustors that are used in pulsejets by disposing a turbulator in the inlet pipe near where it is connected to the combustion chamber to cause increased turbulence in the combustion chamber to enhance fuel/air mixing, increased combustion chamber pressure, and flame-holding.

### CROSS-REFERENCES TO RELATED APPLICATIONS

This application claims the benefit of priority to U.S. Provisional Application Ser. No. 63/613,632, filed Dec. 21, 2023, the disclosure of which is incorporated by reference in its entirety.

### FIELD OF THE INVENTION

The present invention relates to systems and methods for fuel-air mixing for use in jet engines.

### BACKGROUND OF THE INVENTION

A conventional valveless-type combustor or pulsejet engine preferably includes a combustion chamber, an inlet pipe, fuel injector(s), spark plug (or other ignition device), and an exhaust pipe, which is sometimes referred to as a “tailpipe.” These conventional pulsejet engines may be configured straight or U-shaped. The combustion chamber, inlet pipe and exhaust pipe are often cylindrical. Typically, the diameters of the inlet and exhaust pipes are less than the diameter of the combustion chamber. Further, the length of the inlet pipe is typically less than the length of the exhaust pipe.

When a fuel and air mixture is introduced into the combustion chamber, the spark plug or other ignition device is activated to produce a high-temperature source that ignites the fuel/air mixture. The ensuing combustion process causes a rise in the temperature and pressure of the gases inside the combustion chamber. These gases then expand and escape through the inlet and exhaust pipes. The high velocity of the escaping gases causes an overexpansion and negative pressure inside the combustion chamber. This negative pressure then reverses the direction of the flow in the inlet and exhaust pipes. Fresh air sucked in from the atmosphere via the inlet pipe reaches the combustion chamber because of its shorter length mixes with the fuel that is injected either in the inlet pipe or directly into the combustion chamber. The new fuel/air mixture enters the combustion chamber where it encounters the high-temperature combustion products from the previous combustion event. These combustion products ignite this new fuel/air mixture to produce another combustion event and the process repeats indefinitely as long as there is fuel being injected into the combustion chamber as described.

In tracking the combustion events, there is also flow reversal in the exhaust pipe due to the negative pressure in the combustion chamber. However, due to the length of the exhaust pipe, the fresh air drawn in from the atmosphere does not typically reach the combustion chamber before the next combustion event. Also, the spark plug is only needed to start initial operation of the engine, and is not necessary to sustain the operation of the engine. Therefore, the spark plug can be turned off once the engine is started.

The result of the working cycle of a pulse combustor is that the inlet and exhaust ends produce oscillating flows, i.e., intermittent jets of gas that emanate from them and are responsible for thrust generation. The exhaust pipe usually generates the greatest amount of thrust, but the inlet pipe can also generate a significant amount of thrust, which typically would be on the order of two-thirds (⅔) the thrust generated by the exhaust pipe. Therefore, in order to capture the thrust generated by both the inlet and exhaust pipes, both pipes should be pointed in the same direction. Typically, this is accomplished by the exhaust pipe being bent so that the inlet pipe points in the same direction as the exhaust pipe, giving the engines a “U-shape”.

Pulse combustors can have a number of different forms. Some have multiple inlets, while others have inlets that are perpendicular to the exhaust pipe. Nevertheless, all these embodiments have the same working principle as described above.

Advantages of pulse combustors include the ability to draw in fresh air and sustain operation without any external machinery or moving parts. Pulse combustors have been used as thrust-producing devices, in which case they are commonly referred to as “pulsejet”, “pulse jet” or “wave” engines. Pulsejet engines have a long history and have been used to propel several types of aircraft over the last century. They are often characterized by a diverging exhaust pipe to aid in thrust production.

As with most types of combustors, it is often advantageous for there to be turbulence present in the combustion chamber of pulse combustors. Regions of turbulent flow, particularly where gasses are flowing in circular patterns (commonly known as “recirculation zones” in the scientific and technical literature), encourage fuel-air mixing and also provide a persistent source of reacting gasses and heat for reignition of subsequent combustion cycles, i.e., for flame-holding. It is therefore advantageous to devise system and methods that encourage the development of turbulence and the presence of recirculating regions inside the combustion chamber.

### SUMMARY OF THE INVENTION

The present invention is directed to the placement of a ring or other protrusion(s) inside the inlet pipe at or near the interface with the combustion chamber of a pulse combustor. This ring or other protrusion(s) acts to increase turbulence in the incoming airflow for stronger turbulence and recirculation inside the combustion chamber, which leads to better fuel-air mixing, and therefore faster heat release and better flame-holding. The ring or other protrusion(s) also leads to higher blockage for flow leaving the combustion chamber, which allows for higher combustion pressures to be attained from the periodic combustion.

### BRIEF DESCRIPTION OF THE DRAWING(S)

FIG. 1 shows a representative side view of a U-shape pulse combustor, according to certain embodiments.

FIG. 2 shows a representative top left perspective view of a U-shape pulse combustor, according to certain embodiments.

FIG. 3 shows a close-up of a representative side view of an embodiment of the present invention with an interior ring show in phantom in the inlet pipe.

FIG. 4 shows a representative top left perspective view of an embodiment of the present invention with an interior ring shown in phantom in the inlet pipe.

FIG. 5 shows a representative top left perspective view of an embodiment of the present invention with interior triangular tabs shown in phantom in the inlet pipe.

### REFERENCE NUMERALS IN THE DRAWING(S)

| Ref. | | Ref. | |
|---|---|---|---|
| No. | Description | No. | Description |
| 10 | Pulse Combustor | 16 | Exhaust Pipe |
| 12 | Inlet Pipe | 18 | Fuel Supply and Injection Apparatus |
| 14 | Combustion Chamber | 22 | Inlet Turbulator |
| 24 | Triangular Tab Inlet | | |
| | Turbulator | | |

### DETAILED DESCRIPTION OF THE INVENTION

With respect to this Specification, it is understood that the terms “pulse combustor,” “pulse jet engine,” “pulse jet,” “pulsejet engine,” “pulsejet,” or “wave engine” are used synonymously. It is understood that a pulsejet or pulse jet engine is a pulse combustor that is used for thrust production. It is also understood that wave engines are a class or family of engines that use pressure waves for operation, within which a type of engine is a pulsejet engine.

As with most combustors, it is advantageous to have regions of turbulent and recirculating flow inside the combustion chamber of pulse combustors. Such regions encourage fuel-air mixing and the subsequent rapid release of heat, and also provide a persistent source of reacting gasses and heat for the reignition of fuel-air charges drawn in by subsequent combustion cycles. Furthermore, it can also be advantageous for pulse combustors to have increased blockage (resistance) for flow exiting the combustion chamber to allow for a buildup of higher pressure inside the combustion chamber following a combustion event, because this often leads to higher useful mechanical energy output.

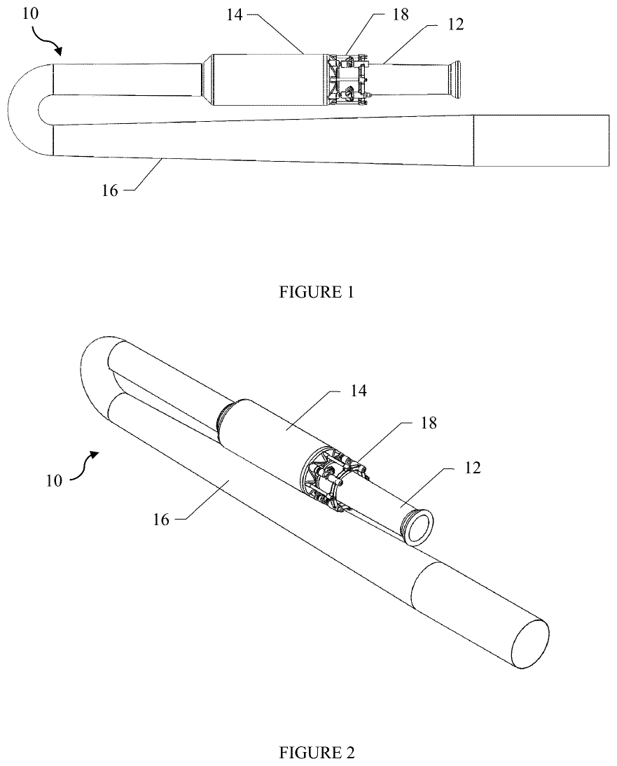

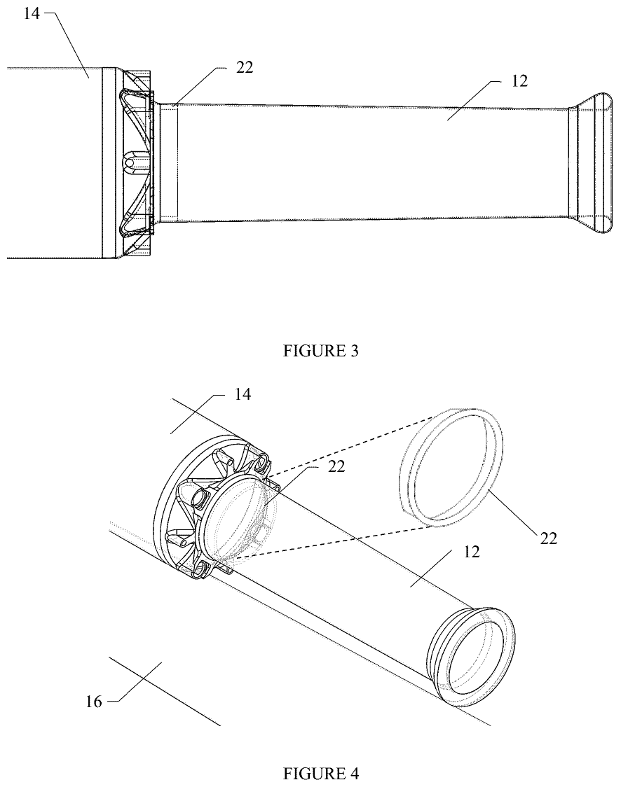

Generally, at 10, FIGS. 1 and 2 show representative side and perspective views of a pulse combustor. Preferably, pulse combustor 10 includes inlet pipe 12 connected to one open end of combustion chamber 14. The other open end of combustion chamber 14 is connected to exhaust pipe 16. Pulse combustor 10 also includes fuel supply and injection apparatus 18 connected to combustion chamber 14 for supplying and injecting fuel into combustion chamber 14. Although not visible in FIGS. 1 and 2, pulse combustor 10 also includes inlet turbulator 22 inside inlet pipe 12. Further, pulse combustor 10 includes a spark plug or other ignition device (not shown) for igniting the fuel/air mixture in combustion chamber 14. This component is known in the art. \FIGS. 3 and 4 show representative side and perspective views of pulse combustor 10. These figures show in detail the inlet pipe 12 and inlet turbulator 22. The dashed lines in FIGS. 3 and 4 are to indicate the internal geometry of the portions of the pulse combustor shown. Fuel supply and injection apparatus 18 is not shown in FIGS. 3 and 4 only for purposes of visual clarity. However, a person of ordinary skill in the art referring to FIGS. 3 and 4 would understand the placement of fuel supply and injection apparatus 18 in FIGS. 3 and 4.

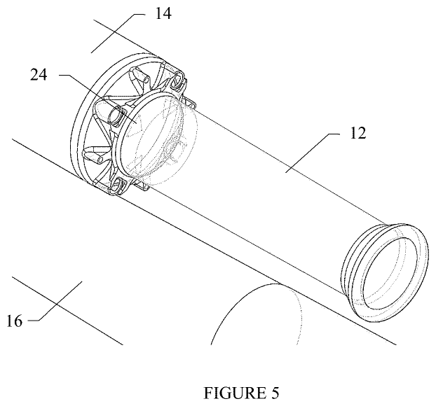

FIG. 5 shows a perspective view of pulse combustor 10. This figure shows in detail the inlet pipe 12 that includes triangle tab inlet turbulator 24. For purposes of illustration, FIG. 5 shows four triangular tabs spaced around the interior of inlet pipe 12. It is understood that more or less than four tabs may be used and still be within the scope of the present invention. Further, geometric shapes other than triangular tabs may be and still be in the scope of the present invention if such shapes will disrupt the laminar flow of air in the inlet pipe that enters the combustion chamber.

The dashed lines in FIG. 5 are to indicate the internal geometry of the portions of the pulse combustor shown. Fuel supply and injection apparatus 18 is not shown in FIG. 5 only for purposes of visual clarity. However, a person of ordinary skill in the art referring to FIG. 5 would understand the placement of fuel supply and injection apparatus 18 in FIG. 5.

As shown in FIGS. 3 and 4, an embodiment of inlet turbulator 22 is an annular ring placed inside the inlet pipe 12 near the end that connects to the combustion chamber 14. The centerline of inlet turbulator 22 is aligned with the centerline of inlet pipe 12, and the outer wall of inlet turbulator 22 is nominally coincident with the inner wall of inlet pipe 12. The edges of inlet turbulator 22 are preferably sharp so as to provide increased flow irregularity and turbulence. Further, the thickness, width, and edge radius of the ring can impact the level of turbulence that is produced.

In normal operation, inlet turbulator 22 acts as a disturbance to the airflow inside inlet pipe 12. During the gas ingestion phase of the pulse combustor cycle, inlet turbulator 22 increases the turbulence level of the air entering the combustion chamber, particularly in the area adjacent to the expanding wall of the combustion chamber known in the art as the “recirculation zone”, which is advantageous for fuel-air mixing and, therefore, heat release. The increased turbulence and recirculating flames (gasses) in this region are also advantageous for providing a persistent source of reacting gasses and heat for the reignition of fuel-air mixtures drawn in by subsequent combustion cycles, i.e., it is advantageous for flame-holding.

Furthermore, during the gas outflow phase of the pulse combustor cycle, inlet turbulator 22 also impedes combustion gases from leaving the combustion chamber following a combustion event, thereby allowing for higher combustion pressures, which is also advantageous for pulse combustor operation.

The present invention includes other embodiments which may or may not have been explicitly described above but adhere to the same principle of operation. In different embodiments of the present invention, inlet turbulator 22 may not be circumferentially uniform or ring shaped. In some embodiments, inlet turbulator 22 can include a plurality of projections or tabs that protrude inward into inlet pipe 12 at an angle relative to the axis of inlet pipe 12 at an axial location at or near the interface between inlet pipe 12 and combustion chamber 14. In some embodiments, as shown in FIG. 5, triangular tab inlet turbulator 24 may consist of multiple triangular tabs that protrude inward into inlet pipe 12 at an angle relative to the axis of inlet pipe 12 at an axial location at or near the interface between inlet pipe 12 and combustion chamber 14. It is understood that the triangular tab inlet turbulator 24 can consist of a circular shape, a rectangular shape, a polygon shape, or a combination thereof, and still be within the scope of the present invention. While this may change the specifications of the apparatus, it does not change the basic concept of the device and principle of operation, i.e., that gas flowing in the inlet pipe is perturbed and/or impeded near the interface with the combustion chamber. Therefore, it is understood that inlet turbulator 22 may have a different configuration and still be within the scope of the present invention as long as it impacts the inlet pipe air flow in the same or similar manner.

The described embodiments of the present invention in this Specification are meant to be representative of the use of turbulators and mixing enhancement apparatuses within a pulsejet engine. However, someone of ordinary skill in the art would understand other embodiments are possible that will be within the scope of the present invention. Accordingly, what is described in this Specification is meant for purposes of description not limitation.

1. An improved pulse combustor for increasing operational performance, comprising:
A. an inlet pipe having a first length and first central axis, and an open first end with a first diameter and an open second end with a second diameter, and the second diameter is greater than the first diameter;
B. a combustion chamber in fluid communication with the inlet pipe having a second length and a second central axis that is aligned with the first central axis of the inlet pipe, and a third diameter, the combustion chamber having a first end and a second end, with the first end of the combustion chamber sealably connecting to the second end of the inlet pipe;
C. a fuel supply system connected to the combustion chamber for injecting fuel into the combustion chamber for mixing with air from the inlet pipe to form a combustible mixture for ignition within the combustion chamber;
D. an ignition means for igniting fuel air mixtures in the combustion chamber on a predetermined basis;
E. an exhaust pipe in fluid communication with the combustion chamber having a third length greater than a combined length of the inlet pipe and combustion chamber, with the exhaust pipe having a first end and a second end, and the first end of the exhaust pipe has a fourth diameter that is less than the third diameter of the combustion chamber and the second end of the exhaust pipe having a fifth diameter that is greater than the fourth diameter, with a third central axis of the exhaust pipe at the first end being aligned with the first and second central axes of the inlet pipe and combustion chamber, respectively, and with the first end of the exhaust pipe sealably connecting to the second end of the combustion chamber; and
F. a turbulator disposed within the inlet pipe substantially near the second end of the inlet pipe, with the turbulator disrupting the laminar air flow within the inlet pipe to cause increased levels of turbulence in air in the combustion chamber, fuel/air mixing, and recirculating flames.

2. The system as recited in claim 1, wherein the pulse combustor includes a U-shape.

3. The system as recited in claim 1, wherein the turbulator causes air turbulence in a recirculating zone of the combustion chamber.

4. The system as recited in claim 3, wherein the recirculating zone of the combustion chamber includes an area within the combustion chamber adjacent to a wall formed where the second end of the inlet pipe connects to the first end of the combustion chamber.

5. The system as recited in claim 4, wherein the turbulator includes being in a form of an annular ring with a predetermined thickness and width to control a level of turbulence in the recirculating zone.

6. The system as recited in claim 4, wherein the annular ring includes a central axis aligned with the central axis of the inlet pipe.

7. The system as recited in claim 5, wherein the annular ring includes having sharp edges presented to the laminar air flow in the inlet pipe.

8. The system as recited in claim 4, wherein the turbulator includes a plurality of projections within the inlet pipe substantially near the second end of the inlet pipe extending toward the first central axis of the inlet pipe.

9. The system as recited in claim 8, wherein the projections include triangular shaped projections.

10. The system as recited in claim 1, wherein use of the turbulator during pulse combustor operation increases pressure within the combustor chamber.
